(19) United States
(12) Patent Application Publication
(10) Pub. No.: US 2023/0163267 A1
(43) Pub. Date: May 25, 2023

(54) Electrode With Reduced Camber and Manufacturing Method Thereof

(71) Applicant: LG Energy Solution, Ltd., Seoul (KR)

(72) Inventors: Ji Woo Jeong, Daejeon (KR); Hyoung Kwon Kim, Daejeon (KR)

(73) Assignee: LG Energy Solution, Ltd., Seoul (KR)

(21) Appl. No.: 17/975,946

(22) Filed: Oct. 28, 2022

(30) Foreign Application Priority Data
Oct. 5, 2021 (KR) 10-2021-0131654

(51) Int. Cl. H01M 4/04; H01M 4/66

(52) U.S. Cl. CPC H01M 4/0471; H01M 4/0404; H01M 4/0435; H01M 4/661; H01M 2004/021

(57) ABSTRACT

The present technology relates to an electrode with a reduced camber and a method of manufacturing the same, and particularly, to a method of manufacturing an electrode in which the generation of a camber is reduced in an uncoated part of an electrode manufactured using a metal sheet for electrodes in which a first region and a second region of the metal sheet for an electrode have different elongations.

### TECHNICAL FIELD

The present invention relates to an electrode with a reduced camber and a method of manufacturing the same.

### BACKGROUND TECHNOLOGY OF THE INVENTION

As technology for mobile devices has developed, and the demand for such mobile devices has increased, the demand for secondary batteries has also rapidly increased. Among the secondary batteries, lithium secondary batteries have high energy density and operating voltage and excellent storage and lifetime characteristics and thus are widely used as energy sources for various types of electronic products as well as various types of mobile devices.

As the field of application of secondary batteries expands, the demand for secondary batteries having higher capacity is rapidly increasing. As a method of increasing the capacity of a secondary battery, in addition to a technique of increasing a loading amount of a mixture layer, as shown in FIG. 1, a technique of roll-pressing a metal sheet including a mixture layer is being considered.

However, when a thickness of a metal sheet used as an electrode current collector is made thin and the roll-pressing density is increased, as shown in FIGS. 2 and 3, the metal sheet is deformed, and a camber is generated. Specifically, an uncoated part 21a on which a mixture layer is not formed and a coated part 11 on which a mixture layer is formed have different thickness before roll-pressing, and thus tension acting on the uncoated part 21a and the coated part 11 during roll-pressing is different. Accordingly, after roll-pressing, the uncoated part 21a is elongated more than the coated part 11 to generate a camber. When the camber is generated on the metal sheet, disconnection may occur in a notching process, and a lamination position defect may be caused. Therefore, there is an urgent need for a method of reducing the generation of a camber of a metal sheet.

### DESCRIPTION OF THE INVENTION

### Technical Problem

The present invention is believed to solve at least some of the above problems. For example, an aspect of the present invention provides a method of manufacturing an electrode, which minimizes the deformation of a metal sheet for an electrode and prevents the generation of a camber in a process of roll-pressing an electrode, and a manufactured electrode.

### Technical Solution

The present invention provides an electrode with a reduced camber,

A method of manufacturing an electrode with a reduced camber includes heat-treating a metal sheet for an electrode including a first region and a second region divided in a transverse direction (TD) under a condition in which a temperature difference of 10° C. or more is applied between the first region and the second region, applying an electrode slurry on the first region of the heat-treated metal sheet and forming a mixture layer, androll-pressing the metal sheet on which the mixture layer is formed.

In the heat-treated metal sheet, an elongation deviation between the first region and the second region may be 5% or more on average, and in the roll-pressed metal sheet, an elongation amount deviation between the first region and the second region may be 3% or less on average.

In the heat-treating of the metal sheet, a heat treatment temperature of the first region may be in a range of 150° C. to 190° C., a heat treatment temperature of the second region may be in a range of 170° C. to 220° C., andthe heat treatment temperature of the second region may be at least10° C. higher than the heat treatment temperature of the first region.

The heat-treating of the metal sheet may include performing the heat-treating in a state in which the first region of the metal sheet is masked with a heat insulation material.

The heat-treating of the metal sheet may include performing the heat-treating in a chamber in a state in which the metal sheet is in a form of a wound metal sheet roll and a region corresponding to the first region of an outer surface of the metal sheet roll is masked with a heat insulation material.

The heat insulation material may include at least one selected from the group consisting of a metal nitride, a metal oxide, a ceramic, and a carbon fiber.

The metal sheet may have a structure in which the first region and the second region are alternately repeated in the TD.

The forming of the mixture layer may include applying the electrode slurry on an electrode sheet and then drying the electrode slurry.

The method may further include, after the roll-pressing of the metal sheet, cutting the metal sheet to correspond to a shape of an electrode.

The present invention provides a metal sheet for an electrode with a reduced camber.

A metal sheet for an electrode includes a first region and a second region divided in a TD, wherein an elongation deviation between the first region and the second region is 5% or more on average.

The metal sheet may have a structure made of aluminum or an alloy thereof.

The present invention provides an electrode with a reduced camber.

An electrode includes a metal sheet for an electrode including a first region and a second region divided in a TD, wherein an elongation deviation between the first region and the second region is 5% or more on average, the metal sheet has a structure in which a mixture layer is formed in the first region, andan elongation amount deviation between the first region and the second region is 3% or less on average.

### Advantageous Effects

In an electrode and a method of manufacturing the same according to the present invention, a heat treatment process is differently performed on a metal sheet, thereby suppressing the generation of a camber and minimizing a loss even when a roll-pressing process is performed.

### BRIEF DESCRIPTION OF THE DRAWINGS

FIG. 1 a view illustrating a process of roll-pressing a conventional metal sheet for an electrode.

FIG. 2 is an enlarged view of area A of FIG. 1 which illustrates that a camber is generated in a second region, which is an uncoated region, after roll-pressing.

FIG. 3 is a view illustrating a height of a curvature, which is caused by a camber, in a cross section along line B-B′ of FIG. 2, based on a flat surface having no camber.

FIG. 4 is a view illustrating a metal sheet for an electrode which is heat-treated in a chamber in a state in which a first region of the metal sheet for an electrode is masked with a heat insulation material according to one embodiment of the present invention.

FIGS. 5 and 6 are views each illustrating a metal sheet for an electrode according to one embodiment of the present invention.

FIG. 7 is a schematic view illustrating a system for manufacturing an electrode according to one embodiment of the present invention.

### BEST MODE FOR CARRYING OUT THE INVENTION

Hereinafter, the present invention will be described in detail. Prior to the description, it should be understood that terms used in the present specification and the appended claims should not be construed as being limited to general and dictionary meanings, but interpreted based on the meanings and concepts corresponding to technical ideas of the present disclosure on the basis of the principle that the inventor can appropriately define the concepts of terms to describe his/her invention in the best way.

“Elongation” in the present invention is a value indicating the intrinsic property of a material and indicates an extent to which a material is stretched when a constant force is applied. The elongation may be represented by, for example, Equation 1 below.

$$\begin{matrix}\text{elongation} \left(\%\right) = \\ \left\{\begin{matrix}\left(\text{gauge length after fracture - original gauge length}\right) \text{/} \\ \left(\text{original gauge length}\right)\end{matrix}\right\} \times \text{100}\end{matrix}$$

In addition, an “elongation amount” is a value indicating an extent to which a material is stretched according to the magnitude of a force applied to the material. The elongation amount means a relative value.

In addition, a first region of a metal sheet for an electrode is a region in which a mixture layer is formed. Based on before and after an operation of forming the mixture layer, the first region is a region in which the mixture layer is to be formed or a region in which the mixture layer has been formed. The region in which the mixture layer is to be formed may be used interchangeably with a preliminary coated part, and the region in which the mixture layer has been formed may be used interchangeably with a coated part.

In addition, a second region of the metal sheet for an electrode is a region in which the mixture layer is not formed. Based on before and after the operation of forming the mixture layer, the second region is a region in which the mixture layer is to not be formed or a region in which the mixture layer has not been formed. The region in which the mixture layer is to not be formed may be used interchangeably with a preliminary uncoated region, and the region in which the mixture layer has not been formed may be used interchangeably with an uncoated region.

The present invention provides a method of manufacturing an electrode in which the generation of a camber is reduced.

In one embodiment, the method of manufacturing an electrode includes heat-treating a metal sheet for an electrode including a first region and a second region divided in a transverse direction (TD) under a condition in which a temperature difference of 10° C. or more is applied between the first region and the second region, applying an electrode slurry on the first region of the heat-treated metal sheet and forming a mixture layer, and roll-pressing the metal sheet on which the mixture layer is formed.

Specifically, the metal sheet is divided into the first region and the second region in the TD direction perpendicular to a machine direction (MD). The first region of the metal sheet is a region which is to be a coated part, and the second region is a region which is to be an uncoated part. When the metal sheet is heat-treated, elongation, which is a physical property of the metal sheet, is changed. When the metal sheet is heat-treated under a condition in which a temperature difference of 10° C. or more is applied between the first region and the second region of the metal sheet, elongation of metals in the first region and the second region are changed differently. After the electrode slurry is applied on the first region of the metal sheet having different elongations to form the mixture layer, the metal sheet on which the mixture layer is formed is roll-pressed, thereby manufacturing an electrode in which a camber is reduced.

In addition, it is possible to manufacture an electrode in which an elongation deviation between the first region and the second region in the heat-treated metal sheet is 5% or more on average, and an elongation amount deviation between the first region and the second region in the roll-pressed metal sheet is 3% or less on average.

According to a conventional manufacturing method, in the roll-pressing, since a mixture layer is formed in a first region, the first region is thicker than a second regionand thus has an elongation amount that is greater than that of the second region, whereas the second region thinner than the first region has an elongation amount that is smaller than that of the first region. Accordingly, in order to reduce an elongation amount deviation between the roll-pressed first region and second region, elongation of the second region should be set to be greater than elongation of the first region.

Specifically, when the first region and the second region are heat-treated at different temperatures, and a metal sheet, in which the first region and the second region have an elongation deviation of 5% or more on average, is roll-pressed, an elongation amount deviation between the first region and the second region of the roll-pressed metal sheet is 3% or less on average, thereby manufacturing an electrode in which the generation of a camber is reduced. However, when a metal sheet, in which the first region and the second region has an elongation deviation of 5% or less on average, is roll-pressed, since an elongation amount deviation between the rolled first region and second region is 3% or more, the elongation amount deviation between the first region and the second region is not decreased, and thus the generation of a camber is not considerably reduced.

A metal sheet heat-treated at a high heat treatment temperature has relatively greater elongation than a metal sheet heat-treated at a lower heat treatment temperature. Accordingly, since the elongation of the second region should be greater than the elongation of the first region, the second region should be heat-treated at a higher temperature as compared with the first region.

Specifically, in the heat-treating of the sheet, a heat treatment temperature of the first region is set to be in a range of 150° C. to 190° C., and a heat treatment temperature of the second region is set to be in a range of 170° C. to 220° C. The heat treatment temperature of the second region may be set to be at least 10° C. higher than the heat treatment temperature of the first region. Preferably, the heat treatment temperature of the first region may be in a range of 160° C. to 180° C., and the heat treatment temperature of the second region may be in a range of 180° C. to 210° C. This is because, since the time required for heat treatment is increased as the heat treatment temperature of the first region and the heat treatment temperature of the second region are decreased, efficiency is decreased, whereas when the heat treatment temperature of the first region and the heat treatment temperature of the second region are too high, elongation of the metal sheet changes rapidly, and thus it is difficult to adjust the elongation. Moreover, when the heat treatment temperature of the second region is less than 10° C. lower than the heat treatment temperature of the first region, after heat-treating, an elongation deviation between the first region and the second region is not sufficient to prevent the generation a camber, and thus the generation of a camber is not considerably reduced after roll-pressing.

In addition, the heat treating may be performed through convection due to hot air under the atmosphere, heating by a heat source such as a chamber, or both the convention and the heating.

As an example, the heat-treating of the metal sheet may include performing heat treatment in a state in which the first region of the metal sheet is masked with a heat insulation material.

Specifically, as shown in FIG. 4, in a state in which the metal sheet is in the form of a wound metal sheet roll, and a region corresponding to the first region in an outer surface of the metal sheet roll is masked with a heat insulation material, heat treatment may be performed in a chamber. Even when the first region and the second region are heat-treated in one chamber under the same temperature condition, the unmasked second region is heated to a higher temperature than the first region masked with the heat insulation material. The heat insulation material may include at least one selected from the group consisting of a metal nitride, a metal oxide, a ceramic, and a carbon fiber. In addition to the group listed above, the heat insulation material may include any material that is usable as a heat insulation material.

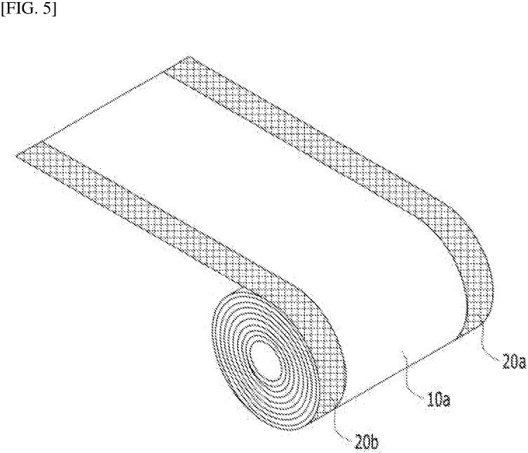

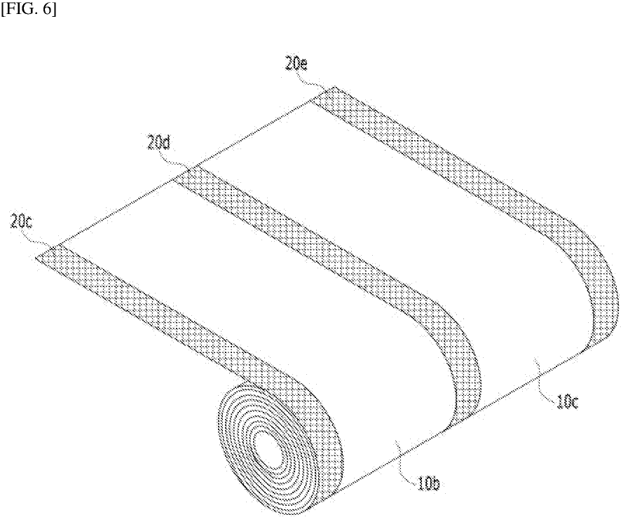

In addition, the metal sheet may have a structure in which the first and second regions are alternately repeated in the TD. As an example, as shown in FIG. 5, the metal sheet may have a second region 20b, a first region 10a, and a second region 20a in the TD from one side of the metal sheet to the opposite side. As another example, as shown in FIG. 6, the metal sheet may have a second region 20c, a first region 10b, a second region 20d, a first region 10c, and a second region 20e in the TD from one side of the meta sheet to the opposite side. FIGS. 5 or 6 is merely an example, and the number of the first regions or the second regions is not limited in an embodiment.

In addition, the forming of the mixture layer may include applying the electrode slurry on the electrode sheet and then drying the electrode slurry.

The mixture layer may be an electrode active material layer and may include an electrode active material, a conductive material, and a binder. The electrode active material may be a positive electrode active material and a negative electrode active material. The positive electrode active material may be a lithium-containing oxide and may be the same or different. As the lithium-containing oxide, a lithium-containing transition metal oxide may be used.

For example, the lithium-containing transition metal oxide may be any one selected from the group consisting of LiₓCoO₂ (0.5<x<1.3), LiₓNiO₂ (0.5<x<1.3), LiₓMnO₂ (0.5<x<1.3), LiₓMn₂O₄ (0.5<x<1.3), Liₓ(NiₐCo_{b}Mn_{c})O₂ (0.5<x<1.3, 0<a<1, 0<b<1, 0<c<1, and a+b+c=1), LiₓNi_{1-y}Co_{y}O₂ (0.5<x<1.3 and 0<y<1), LiₓCo_{1-y}Mn_{y}O₂ (0.5<x<1.3 and 0<y<1), LiₓNi_{1-y}Mn_{y}O₂ (0.5<x<1.3 and O<y<1), Liₓ(NiₐCo_{b}Mn_{c})O₄ (0.5<x<1.3, 0<a<2, 0<b<2, 0<c<2, and a+b+c=2), LiₓMn_{2-z}Ni_{z}O₄ (0.5<x< 1.3 and 0<z<2), LiₓMn_{2-z}Co_{z}O₄ (0.5<x< 1.3 and 0<z<2), LiₓCoPO₄ (0.5<x<1.3), and LiₓFePO₄ (0.5<x<1.3) or a mixture of two or more thereof. In addition, the lithium-containing transition metal oxide may be coated with a metal such as aluminum (Al) or a metal oxide. Furthermore, in addition to the lithium-containing transition metal oxide, at least one selected from among a sulfide, selenide, and halide may be used.

A carbon material, a lithium metal, silicon, or tin may be used as the negative electrode active material. When a carbon material is used as the negative electrode active material, both low-crystalline carbon and high-crystalline carbon may be used. Representative examples of the low-crystalline carbon include soft carbon and hard carbon, and representative examples of the high-crystalline carbon include natural graphite, kish graphite, pyrolytic carbon, mesophase pitch based carbon fiber, meso-carbon microbeads, mesophase pitches, and high-temperature sintered carbon such as petroleum or coal tar pitch derived cokes.

The conductive material is typically added in an amount of 1 wt% to 30 wt% based on the total weight of a mixture including the positive electrode active material. Any conductive material may be used without particular limitation as long as the conductive material has conductivity without causing chemical changes in a battery. For example, graphite such as natural graphite or artificial graphite, carbon black such as acetylene black, Ketjen black, channel black, furnace black, lamp black, or thermal black, a conductive fiber such as a carbon fiber or a metallic fiber, metallic powders such as carbon fluoride, aluminum, or nickel powders, a conductive whisker such as a zinc oxide or potassium titanate whisker, a conductive metal oxide such as titanium oxide, or a conductive material such as a polyphenylene derivative may be used. The binder is a component that assists in bonding an active material and a conductive material and bonding a metal sheet for an electrode and is typically added in an amount of 1 wt% to 30 wt% based on the total weight of the mixture including the positive electrode active material.

As the binder, a water-insoluble polymer that is soluble in an organic solvent and insoluble in water may be used, or a water-soluble polymer that is insoluble in an organic solvent and soluble in water may be used. The water-insoluble polymer may be at least one selected from the group consisting of polyvinylidene fluoride (PVDF), polyvinylidene chloride (PVDC), polyacrylonitrile (PAN), polypropylene oxide (PPO), a polyethylene oxide-propylene oxide copolymer (PEO-PPO), polytetrafluoroethylene (PTFE), polyimide (PI), polyetherimide (PEI), styrene butadiene rubber (SBR), polyacrylate, and a derivative thereof.

The water-soluble polymer may include at least one selected from the group consisting of various cellulose derivatives such as carboxymethylcellulose (CMC), methylcellulose (MC), cellulose acetate phthalate (CAP), hydroxypropylmethylcellulose (HPMC), and hydroxypropylmethylcellulose phthalate (HPMCP).

Meanwhile, a binder layer may include a binder and a conductive material. The conductive material and the binder used in the active material described above may be used as the binder and the conductive material, and the same type or different types may be used.

In addition, in the drying, the electrode slurry may be applied on one surface of the metal sheet and then dried. When the mixture layer is to be formed on both surfaces of the metal sheet, the electrode slurry may be applied on one surface of the metal sheet and then primarily dried, and the electrode slurry may be applied on the other surface of the metal sheet and then secondarily dried. The drying may be a process of volatilizing all the solvent of the electrode slurry to completely solidify the electrode slurry and may be the same as a conventional drying process. For example, the drying may be performed in a range of 60° C. to 150° C. for 1 hour or less, specifically, in a range of 80° C. to 150° C. for 10 minutes or less.

In addition, the method may further include a reversing operation of reversing the metal sheet that is primarily dried such that one surface on which the mixture layer is formed and the other surface on which the mixture layer is not formed are reversed.

In addition, the method may further include, after the roll-pressing of the metal sheet, cutting the metal sheet to correspond to a shape of an electrode. Specifically, the second region, which is the uncoated part, may be a positive electrode tab or a negative electrode tab of the electrode, and the first region, which is the coated part, may be a positive electrode plate or a negative electrode plate of the electrode. In addition, the method may further include stacking cut electrodes.

In addition, the present invention provides a metal sheet for an electrode, which reduces the generation of a camber.

In an example, the metal sheet may include a first region and a second region which are divided in a TD, and an elongation deviation between the first region and the second region may be 5% or more. As described above, in order to reduce an elongation amount deviation between the first region, which is a coated part, and the second region, which is an uncoated part, after roll-pressing, elongations of the first region and the second region of the metal sheet need to be adjusted to be different, and an elongation deviation is preferably 5% or more. When the elongation deviation is less than 5%, an elongation amount deviation between the first region and the second region after roll-pressing cannot be reduced, and thus the generation of a camber in the second region cannot be considerably reduced.

In addition, the metal sheet for an electrode may have a structure made of aluminum or an alloy thereof. Specifically, a conductive member made of a metal having high conductivity may be used. Any conductive member may be used without particular limitation as long as the conductive member has high conductivity without causing chemical changes in a battery. When the electrode is a positive electrode, stainless steel, aluminum, nickel, titanium, sintered carbon, or aluminum or stainless steel surface-treated with carbon, nickel, titanium, silver, or the like may be used as the metal sheet. A curvature may be finely formed on a surface of the metal sheet to increase the adhesion of a positive electrode active material, and the metal sheet may be provided in any form of a film, a sheet, a foil, a net, a porous body, a foam, a nonwoven body, or the like. In general, the metal sheet may be formed to have a thickness of 3 µm to 500 µm.

In addition, when the electrode is a negative electrode, stainless steel, aluminum, nickel, titanium, sintered carbon, copper or stainless steel surface-treated with carbon, nickel, titanium, silver, or the like, or an aluminum-cadmium alloy may be used as the metal sheet. In general, the metal sheet may be formed to have a thickness of 3 µm to 500 µm.

In addition, the present invention provides an electrode in which a camber is reduced.

The electrode may be an electrode including a metal sheet which includes a first region and a second region divided in a TD and in which an elongation deviation between the first region and the second region is 5% or more. The electrode may be an electrode having a structure in which a mixture layer is formed in the first region, and an elongation amount deviation between the first region and the second region is 3% or less on average.

In addition, the present invention provides a system for manufacturing an electrode in which a camber is reduced.

Specifically, the system may perform a method including an operation of providing a metal sheet for an electrode in which an elongation deviation between a first region and a second region is 5% or more on average, and elongation of the first region is less than that of the second region, a primary coating operation of applying an electrode slurry on the first region of one surface of the metal sheet for an electrode, a primary drying operation of allowing the primarily coated metal sheet for an electrode to pass through a drying furnace; a secondary coating operation of applying an electrode slurry on a surface opposite to the coated surface of the metal sheet for an electrode subjected to the primary drying operation, and a secondary drying operation of allowing the primarily and secondarily coated metal sheet for an electrode to pass through the drying furnace.

In addition, the method may further include a reversing operation of reversing the metal sheet for an electrode subjected to the primary drying operation such that a first surface and a second surface are reversed.

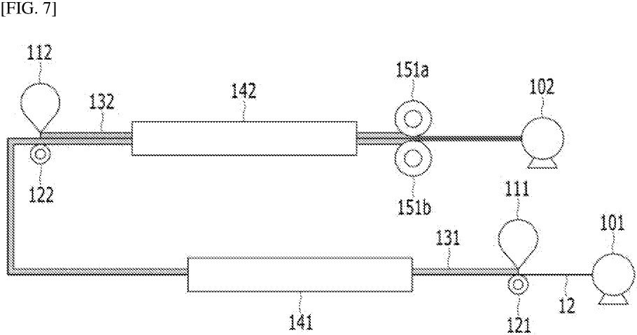

Specifically, FIG. 7 is a schematic view illustrating a system for manufacturing an electrode according to an embodiment of the present invention. Referring to FIG. 7, a metal sheet 12 for an electrode, in which an elongation deviation between a first region 10a and second regions 20a and 20b is 5% or more on average, and elongation of the first region 10a is less than that of the second regions 20a and 20b, may be supplied from an unwinder 101. The supplied metal sheet 12 for an electrode may pass over a first coating roller in an MD. At a time point at which the metal sheet 12 for an electrode passes over the first coating roller 121, an electrode slurry may be discharged from a first electrode slurry slot die 111 to form a first mixture layer 131 in the first region 10a of one surface of the metal sheet for an electrode. After the metal sheet 12 for an electrode passes through a primary drying furnace 141, a coated surface and a surface opposite to the coated surface of the metal sheet 12 for an electrode are reversed by a reversing roller (not shown). The metal sheet 12 for an electrode may pass over a second coating roller 122, and in this case, an electrode slurry may be discharged from a second electrode slurry slot die 112 to form a second mixture layer 132 in the first region 10a of the surface opposite to the coated surface of the metal sheet 12 for an electrode. Then, after the metal sheet 12 for an electrode passes through a secondary drying furnace 142, the metal sheet 12 for an electrode may be roll-pressed by vertically disposed pressing rollers 151a and 151b and then wound by a rewinder 102.

### Examples 1 to 9

An aluminum (Al) sheet with an average size of 20 µm was prepared as a metal sheet for an electrode, and in a TD, a metal sheet 12 for an electrode was divided into a first region 10a in which a mixture layer would be formed and second regions 20a and 20b in which a mixture layer would not be formed. Thereafter, as shown in FIG. 4, the metal sheet 12 for an electrode was in the form of a wound metal sheet roll. Only the first region 10a of an outer surface of the metal sheet roll was masked with a heat insulation material 30 including a carbon fiber as a main component, and heat treatment was performed using a chamber 40.

Specifically, as shown in Table 1 below, by adjusting a temperature of the chamber 40 to set a temperature of the first region 10a and a temperature of the second regions 20a and 20b, which are preliminary uncoated parts, to be different, heat treatment was performed.

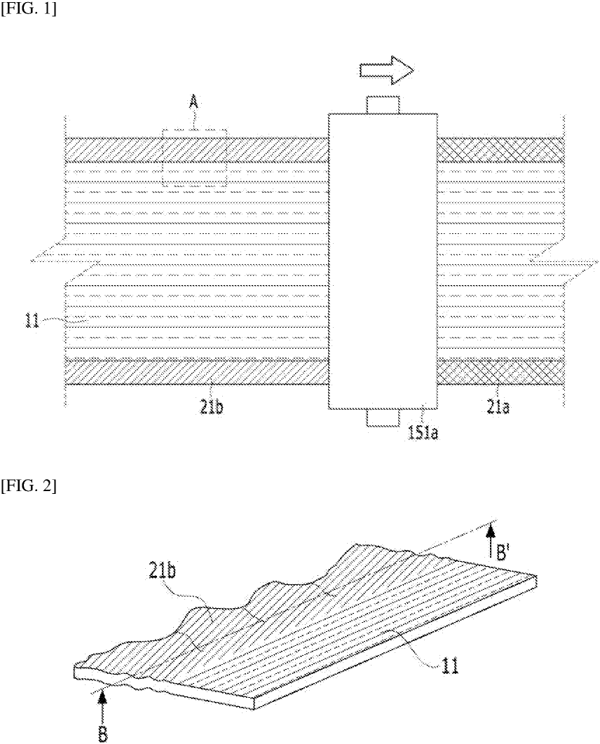

96.25 wt% of LiCoO₂ as a positive electrode active material, 1.5 wt% of carbon black as a conductive material, and 2.25 wt% of PVDF as a binder were added to N-methyl-2pyrrolidone (NMP) as a solvent to prepare a positive electrode mixture slurry. The slurry was applied on a first region 10a of one surface of the metal sheet 12 for an electrode, and a first mixture layer 131 having an average size of 180 µm was formed thereon. A second mixture layer 132 having an average thickness of 120 µm was formed in the first region 10a opposite to a coated surface of the metal sheet 12 for an electrode. Thereafter, as can be seen in FIG. 1, in a metal sheet for an electrode roll-pressed through pressing rollers 151a and 152b at a pressure of 80 N/m², an average elongation amount deviation between a first region 11 which was a coated part and a second region 21b which was an uncoated part was confirmed.

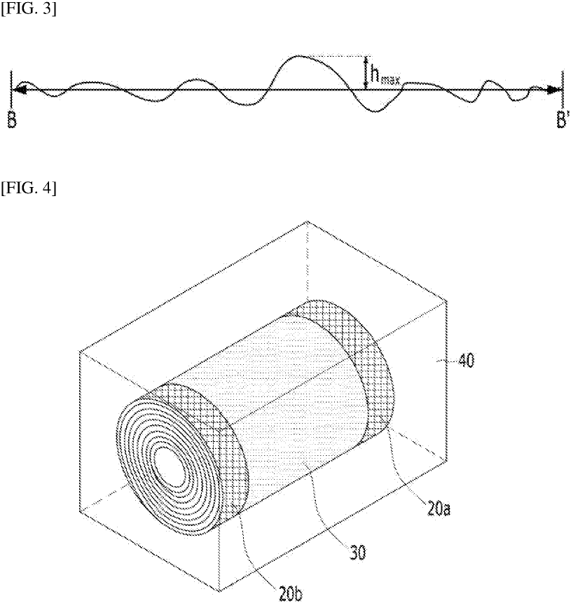

In addition, specifically, as can be seen in FIGS. 2 and 3, in a cross section along line B-B′ of the roll-pressed second region 21b, a maximum height hₘₐₓ of a curvature caused by a camber was measured based on a flat surface having no camber to indirectly confirm a degree of generation of a camber.

### Comparative Examples 1 to 3

A first region and a second region of a metal sheet of for an electrode having a single elongation were heat-treatedat the same temperature. Specifically, in a state in which a first region 10a is not masked with a heat insulation material 30, and as in Examples 1 to 9, heat treatment was performed on the metal sheet in the form of a wound metal sheet roll under temperature conditions of Table 1 below using a chamber 40.

Hereinafter, a mixture layer forming method and a roll-pressing method were performed in the same manner as in Examples 1 to 9, and methods of measuring an average elongation deviation between a first region 11 and a second region 21b of a roll-pressed metal sheet and a maximum height hₘₐₓ of a curvature caused by a camber were also measured in the same manner as in Examples 1 to 9.

TABLE 1

| Classification | Temp(°C) | | Elongation deviation (%) |
|---|---|---|---|
| | First region | Second region | |
| Example 1 | 150 | 180 | 6.1 |
| Example 2 | 160 | 180 | 5.8 |
| Example 3 | 170 | 180 | 3.0 |
| Example 4 | 160 | 190 | 7.5 |
| Example 5 | 170 | 190 | 6.2 |
| Example 6 | 180 | 190 | 3.2 |
| Example 7 | 170 | 200 | 7.7 |
| Example 8 | 180 | 200 | 6.4 |
| Example 9 | 190 | 200 | 3.0 |
| Comparative Example 1 | 180 | 180 | 0 |
| Comparative Example 2 | 190 | 190 | 0 |
| Comparative Example 3 | 200 | 200 | 0 |

Table 1 shows an elongation deviation between the first region 10a and the second regions 20a and 20b when the first region 10a and the second regions 20a and 20b of the metal sheet 12 for an electrode are heat-treated at temperature(s) set as shown in Table 1.

Referring to Table 1, when a temperature difference between the first region 10a and the second regions 20a and 20b of the metal sheet 12 before roll-pressing is 10° C., it can be confirmed that an elongation deviation is less than 5% (Examples 3, 6, and 9).

On the other hand, when a temperature difference between the first region 10a and the second region 20a and 20b is 20° C. or more, it can be confirmed that an elongation deviation exceeds 5% (Examples 1, 2, 4, 5, 7, and 8).

In addition, it can be seen that, in Comparative Examples 1 to 3 in which temperatures of the first region 10a and the second regions 20a and 20b are maintained at the same level, there is no elongation deviation.

Thus, when a temperature difference between the first region 10a and the second regions 20a and 20b is 20° C. or more, it is confirmed that a metal sheet 12 for an electrode having an elongation deviation of 5% or more can be manufactured.

Table 2 shows results of measuring an average elongation amount deviation between the first region 10a and the second region 20b of a metal sheet and results of measuring a maximum height hₘₐₓ of a curvature, wherein the metal sheet is subjected to an operation of forming a mixture layer and a roll-pressing operation using the metal sheet 12 of Table 1 above, and the curvature is caused by a camber of the second region 20b.

TABLE 2

| Classification | Elongation amount deviation (%) | Maximum height of curvature(mm) |
|---|---|---|
| Example 1 | 3.1 | 17.8 |
| Example 2 | 2.0 | 16.5 |
| Example 3 | 7.2 | 19.9 |
| Example 4 | 2.9 | 17.0 |
| Example 5 | 1.8 | 15.0 |
| Example 6 | 7.1 | 20.4 |
| Example 7 | 3.0 | 17.6 |
| Example 8 | 2.1 | 16.3 |
| Example 9 | 7.1 | 20.8 |
| Comparative Example 1 | 8.9 | 24.9 |
| Comparative Example 2 | 9.1 | 25.6 |
| Comparative Example 3 | 9.7 | 26.1 |

According to Table 2, in Examples 3, 6, and 9, when the metal sheet 12, in which an elongation deviation between the first region 10a and the second regions 20a and 20b is less than 5%, was roll-pressed, elongation amount deviations between the first region 11 and the second region 21b of a roll-pressed electrode were measured to be 7.2%, 7.1%, and 7.1%, respectively, and maximum heights hₘₐₓ of a curvature caused by a camber were measured to be 19.9 mm, 20.4 mm, and 20.8 mm, respectively.

In Examples 1, 2, 4, 5, 7, and 8, when a lithium electrode using a metal sheet for an electrode, in which an elongation deviation between the first region 10a and the second regions 20a and 20b more than 5%, was roll-pressed, elongation amount deviations between the first region 11 and the second region 21b of the roll-pressed electrode were measured to be 3.1%, 2.0%, 2.9%, 1.8%, 3.0%, and 2.1%, respectively, and maximum heights hₘₐₓ of a curvature caused by a camber were measured to be 17.8 mm, 16.5 mm, 17.0 mm, 15.0 mm, 17.6 mm, and 16.3 mm, respectively.

In Examples 1, 4, and 7 using a metal sheet in which a temperature difference between the first region 10a and the second regions 20a and 20b, which are preliminary uncoated parts, is 30° C., it can be seen that an elongation amount deviation is relatively greater than that of Examples 2, 5, and 8 in which a temperature difference between the first region 10a and the second regions 20a and 20b is 20° C., and a degree of generation of a camber is greater than that of Examples 2, 5, and 8.

Therefore, it can be confirmed that, when a metal sheet for an electrode, in which a temperature difference between the first region 10a and the second regions 20a and 20b is 20° C., and an elongation deviation is 5% or more, is used, the generation of a camber after roll-pressing is considerably reduced. Further, in Example 5, when a metal sheet for an electrode, in which a temperature of the first region 10a is 170° C. and a temperature of the second regions 20a and 20b is 190° C., is used, since an elongation deviation is the smallest and a degree of generation of a camber is also the lowest, it can be confirmed that it is a more preferable embodiment to perform roll-pressing under such conditions.

In the above, the present invention has been described in more detail through the drawings and embodiments. However, the configurations described in the drawings or the embodiments in the specification are merely embodiments of the present invention and do not represent all the technical ideas of the present invention. Thus, it is to be understood that there may be various equivalents and variations in place of them at the time of filing the present application.

Description of reference numerals

| | | | | | |
|---|---|---|---|---|---|
| 10a, 10b, 10c: | | | | first region that is preliminary coated part | |
| 11: | first region that is coated part | | | | |
| 12: | metal sheet for electrode | | | | |
| 20a, 20b, 20c, 20d, 20e: | | | | | second region that is preliminary uncoated region |
| 21a: | | second region that is uncoated region before roll-pressing | | | |
| 21b: | | second region of uncoated region after roll-pressing | | | |
| 30: | heat insulation material | | | | |
| 40: | chamber | | | | |
| 101: | | unwinder | | | |
| 102: | | rewinder | | | |
| 111: | | first electrode slurry slot die | | | |
| 112: | | second electrode slurry slot die | | | |
| 121: | | first coating roller | | | |
| 122: | | second coating roller | | | |
| 131: | | first mixture layer | | | |
| 132: | | second mixture layer | | | |
| 141: | | primary drying furnace | | | |
| 142: | | secondary drying furnace | | | |
| 151a, 152b: | | | pressing rollers | | |

1. A method of manufacturing an electrode, the method comprising:
heat-treating a metal sheet for an electrode including a first region and a second region divided in a transverse direction (TD) under a condition in which a temperature difference of 10° C. or more is applied between the first region and the second region;
applying an electrode slurry on the first region of the heat-treated metal sheet and forming a mixture layer; and
roll-pressing the metal sheet on which the mixture layer is formed.

2. The method of claim 1, wherein:
an elongation deviation between the first region and the second region of the heat-treated metal sheet is 5% or more on average; and
an elongation amount deviation between the first region and the second region of the roll-pressed metal sheet is 3% or less on average.

3. The method of claim 1, wherein,
in the heat-treating of the metal sheet,
a heat treatment temperature of the first region is in a range of 150° C. to 190° C.,
a heat treatment temperature of the second region is in a range of 170° C. to 220° C., and
the heat treatment temperature of the second region is at least 10° C. higher than the heat treatment temperature of the first region.

4. The method of claim 1, wherein the heat-treating of the metal sheet includes performing the heat-treating in a state in which the first region of the metal sheet is masked with a heat insulation material.

5. The method of claim 1, wherein the heat-treating of the metal sheet includes performing the heat-treating in a chamber in a state in which the metal sheet is in a form of a wound metal sheet roll and a region corresponding to the first region of an outer surface of the metal sheet roll is masked with a heat insulation material.

6. The method of claim 5, wherein the heat insulation material includes at least one selected from the group consisting of a metal nitride, a metal oxide, a ceramic, and a carbon fiber.

7. The method of claim 1, wherein the metal sheet has a structure in which the first region and the second region are alternately repeated in the TD.

8. The method of claim 1, wherein the forming of the mixture layer includes applying the electrode slurry on an electrode sheet and then drying the electrode slurry.

9. The method of claim 1, further comprising, after the roll-pressing of the metal sheet, cutting the metal sheet to correspond to a shape of an electrode.

10. A metal sheet for an electrode comprising a first region and a second region divided in a transverse direction (TD),
wherein an elongation deviation between the first region and the second region is 5% or more on average.

11. The metal sheet of claim 10, wherein the metal sheet has a structure made of aluminum or an alloy thereof.

12. An electrode comprising the metal sheet of claim 10,
wherein:
a mixture layer is formed in the first region;
an elongation deviation between the first region and the second region is 5% or more on average; and
an elongation amount deviation between the first region and the second region is 3% or less on average.
